(19) United States
(12) Patent Application Publication
(10) Pub. No.: US 2024/0425154 A1
(43) Pub. Date: Dec. 26, 2024

(54) ELECTRIC BOAT WITH MOVEABLE BATTERY PACK

(71) Applicants: William J. HURLES, Bloomfield Hills, MI (US); Steven Craig HURLES, White Lake, MI (US)

(72) Inventors: William J. HURLES, Bloomfield Hills, MI (US); Steven Craig HURLES, White Lake, MI (US)

(21) Appl. No.: 18/749,023

(22) Filed: Jun. 20, 2024

Related U.S. Application Data
(60) Provisional application No. 63/522,293, filed on Jun. 21, 2023.

(51) Int. Cl. B63B 39/02; B60L 50/60; B63B 79/40; B63H 21/17

(52) U.S. Cl. CPC B63B 39/02; B60L 50/66; B63B 79/40; B63H 21/17; B60L 2200/32

(57) ABSTRACT

According to an aspect of the disclosure, an electric motor powered boat includes a hull that extends between a bow region and a stern region. An electric motor is provided at the stern region of the boat for propelling the boat. At least one battery pack is electrically connected to the electric motor for powering the electric motor. The battery pack is moveable relative to the hull for relocating a center of mass of the battery pack to shape a wake produced by the boat.

### FIELD OF THE INVENTION

The present disclosure relates to marine vessels, such as boats. More particularly, the present disclosure relates to an electric motor powered boat.

### BACKGROUND

It is known for wakeboarding and wake surfing boats to include wake modifying features to provide a desired size and shape of a wake behind the boat. An example is a ballast system that selectively pumps water into ballasts located at certain regions of a stern region of the boat to increase the size of the wake. Another example is a wake plate that protrudes from a side of a hull of the boat to create water resistance at desired locations and to modify a shape of the wake.

Furthermore, electric vehicles, e.g., cars, recreational vehicles and boats, have become increasingly popular, largely in an effort to reduce fossil fuel consumption. Efforts have been made to electrify wakeboarding and wake surfing boats. There remains a need for improvements to electric boats.

### SUMMARY OF THE INVENTION

According to an aspect of the disclosure, an electric motor powered boat includes a hull that extends between a bow region and a stern region. An electric motor is provided at the stern region of the boat for propelling the boat. At least one battery pack is electrically connected to the electric motor for powering the electric motor. The battery pack is moveable relative to the hull for relocating a center of mass of the battery pack to shape a wake produced by the boat.

The ability to selectively move the center of mass of the battery pack allows the battery pack to serve the dual purposes of powering the electric motor and providing a desired wake shaping/sizing effect.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top schematic view of an embodiment of an electric boat with a moveable battery pack constructed in accordance with the subject disclosure, and illustrating a first arrangement of a seat containing the battery pack;

FIG. 2 is a top schematic view of the electric boat, illustrating a second arrangement of a seat containing the battery pack; and

FIG. 3 is a side, schematic view of another embodiment of an electric boat, illustrating a battery pack that is moveable within a chamber of the boat.

### DESCRIPTION OF THE ENABLING EMBODIMENT

Referring to the figures, wherein like numerals indicate corresponding parts throughout the several views, systems for electric-motor powered boats are provided.

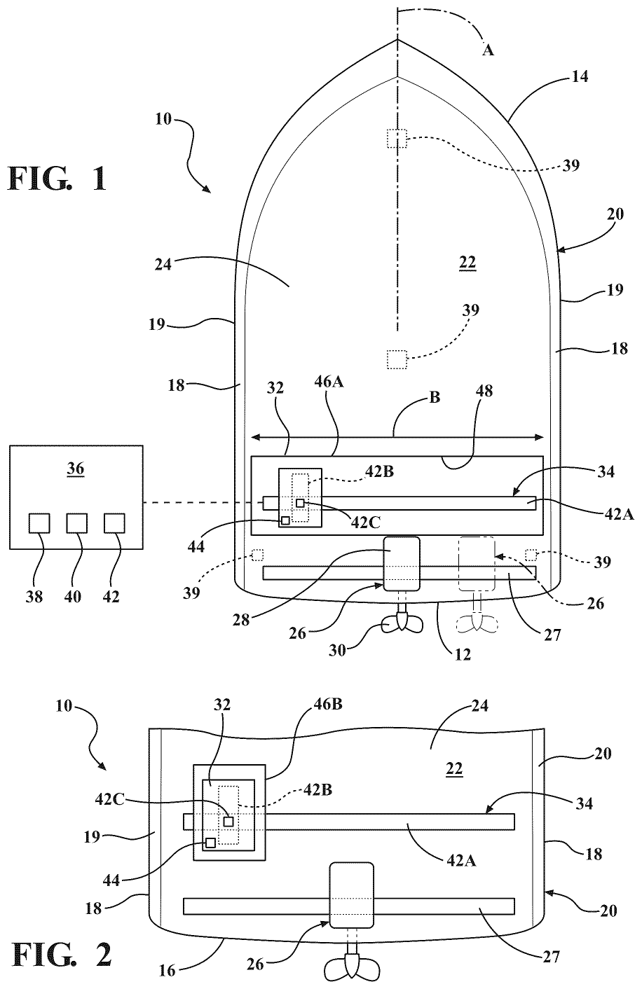

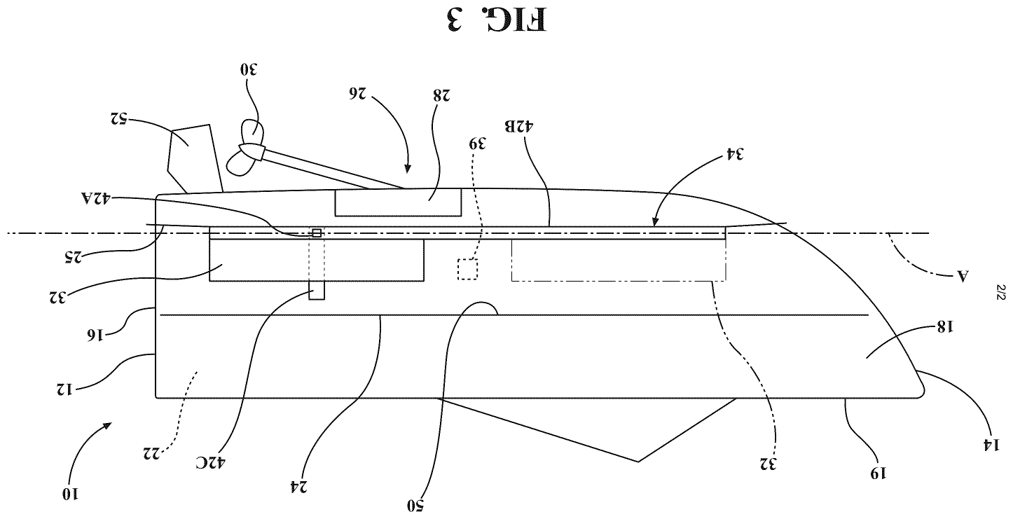

According to an aspect of the disclosure illustrated in FIGS. 1 and 2, an electric motor-powered wake surfing/wake boarding boat 10 is shown. The boat 10 has a hull 20 that extends in a direction of a longitudinal axis A between a stern region 12 and a bow region 14. A transom 16 is located in the stern region 12. A pair of sidewalls 18 extend between the bow and stern regions 12, 14. Gunnels 19 may be located along the sidewalls 18. The hull 20 defines an interior 22 between the stern and bow regions 12, 14 and the sidewalls 18. The hull 20 may be made as one or more pieces of any suitable material, e.g., fiberglass, aluminum, plastic, etc.

A generally planar floor 24 is located in the interior 22. Various arrangements of seats, storage compartments, consoles, etc. may be positioned on and/or connected to the floor 24. The floor 24 may be comprised of any number of floor segments along any number of planes in the vertical direction.

One or more electric outdrives 26 are located at the stern region 12 for propelling the boat 10. According to the preferred embodiment, each electric outdrive 26 may include an electric motor 28 connected to a propeller 30 for generating thrust in water to drive the boat 10. According to the preferred embodiment, the electric outdrive 26 is located at the transom 16, but may be located axially further toward the bow region 14, such that the propeller is located under the hull 11. Other styles of electric outdrives 26 could be used, e.g., a jet propulsion device that utilizes an impeller to generate the thrust rather than a propeller.

One or more motor tracks 27 may be located at the stern region 12 for permitting the one or more electric outdrives 26 to be moved in a width direction B extending between the sidewalls 18, and/or in a vertical direction (in and out of the page relative to FIG. 1) perpendicular to the floor 24. Moving the electric outdrive 26 may be employed to provide a desired wake forming effect by adjusting the location where the thrust is produced and how the hull 20 displaces water when in motion.

A battery pack 32 is located in the interior 22 of the boat 10 and is electrically connected to the electric outdrive 26 for powering the electric outdrive 26. The battery pack 32 may include an arrangement of various types of batteries including, but not limited to lithium ion, alkaline and carbon zinc batteries. In many cases, the battery pack 32 will be massive (heavy) such that its location within the hull 20 will influence the balance of the boat 10 and the way the hull 20 displaces water, and thus, the shape and size of the wake produced by the hull 20. The battery pack 32 may also include a water-proof enclosure or housing The battery pack 32, including the enclosure, is selectively moveable along the floor 24 in order to distribute a weight of the battery pack 32 to different regions of the boat 10 to provide a desired wake forming effect by adjusting where the hull 20 displaces water when in motion. In addition to providing a wake forming effect, moving the center of mass of the battery pack 32 may provide various other performance modifying effects, including adjusting a degree of bouncing through waves, and or adjusting a top speed of the boat.

More particularly, a moving mechanism 34 interconnects the battery pack 32 to a mounting location, such as along, or beneath the floor 24 of the boat 10. The moving mechanism 34 may permit the battery pack 32 to move in any direction including, but not limited to, the direction of the longitudinal axis A, the width direction B, and/or in the vertical direction.

In the exemplary embodiment, the moving mechanism 34 is connected to a controller 36 (schematically shown) that electronically controls the movement of the battery pack 32 according to a driver's preferred settings. The controller 36 may comprise an electronic control unit 40 of the boat 10 which may be controlled via one or more buttons mounted on the boat 10, or via a mobile device 42, e.g., a smart phone or tablet, that is electrically connected to the ECU 38. In an example embodiment, the boat 10 may be provided with a plurality of weight sensors 39 positioned beneath the floor 24 for determining a current distribution of weight within the boat 10. The control unit 40 may be configured to locate the battery pack 32 based, at least partially, on the current distribution of weight. Alternatively, the moving mechanism 34 may permit the battery pack 32 to be manually moved by a user.

The battery pack 32 may be configured to be moved into a plurality of locked positions. More particularly, the battery pack 32 may be configured to lock either automatically or manually upon moving into the locked positions in order to prevent unintended movement of the battery pack 32 during movement of the boat 10. The electric motor 28 may be configured to only operate in response to a detection that the battery pack 32 is located in one of the locked positions to provide increased safety. In other words, boat movement may only be permitted in response to a detection that the battery pack 32 is locked in place in one of the locked positions.

According to the preferred embodiment, the moving mechanism 34 includes a one or more tracks 42A, B, C defined along the floor 24. The battery pack 32 is slidingly coupled to the tracks 42A, B, C to accommodate movement of the battery pack 32. According to the preferred embodiment, one or more pack motors 44 is/are configured to drive movement of the battery pack 32 along the track 42A, B, C. The pack motor(s) 44 may be electrically connected to the battery pack 32 to power the pack motor(s) 44, or the pack motor(s) 44 may be connected to an alternative power source, e.g., a standalone battery. In an example embodiment, the moving mechanism 34 includes two pack motors 44, one for moving the battery pack 32 in the widthwise direction and another for moving the battery pack 32 in a forward/backward direction along the longitudinal axis A. An additional pack motor 44 may be configured to move the battery pack 32 in the vertical direction.

The tracks 42A, B, C may include at least one width segment 42A that extends in the width direction to provide movement of the battery pack 32 in the width direction. The tracks 42A, B, C may further include at least one length segment 42B that extends in the direction of the longitudinal axis A of the boat 10 to provide longitudinal movement of the battery pack 32. The tracks 42A, B, C may also include a vertical segment 42C extending in the vertical direction (into the page) to provide movement of the battery pack 32 in the vertical direction.

The boat 10 may further include at least one seat 46A, B, e.g., a bench seat, adjacent to the transom. The seat 46A, B may define a compartment 48 in which the battery pack 32 is stored. The compartment 48 may be sized large enough such that all movements of the battery pack 32 are contained in the compartment 48 to provide increased safety by preventing movement of the battery pack 32 against occupants while also providing a seating area. For instance, as shown in FIG. 1, the tracks 42A, B, C may be entirely located in the compartment 48 of the seat 46A to accommodate movement of the battery pack 32.

According to another arrangement shown in FIG. 2, the seat 46B may be configured such that it occupies only a portion of the interior 22 of the boat 10 in the width direction B, and the seat 46B is moveable with the battery pack 32 while the battery pack 32 is located in the compartment 48 of the seat 46B. This arrangement may selectively provide access to the floor 24 of the boat 10 (apart from the seat 46B) depending on where the seat 46B is located. The seat 46B may be configured to move with the battery pack 32 into the plurality of locked positions.

According to another embodiment, the tracks 42A, B, C are electrically connected with the one or more electric outdrives 26 and include one or more electric contacts. The battery pack 32 is provided with a corresponding set of contacts. When the contacts of the battery pack 32 are in direct contact with the contacts of the tracks 42A, B, C with the battery pack 32 being in a locked position, the battery pack 32 is electrically coupled to the one or more electric outdrives 26 for supplying power to the electric outdrives 26.

According to another embodiment shown in FIG. 3, the battery pack 32 may be located, and moveable within a chamber 50 located beneath the floor 24. Like the previously described embodiments, this arrangement may include tracks 42A, B, C which may include at least one width segment 42A that extends in the width direction to provide movement of the battery pack 32 in the width direction, and at least one length segment 42B that extends in the direction of the longitudinal axis A of the boat 10 to provide longitudinal movement of the battery pack 32. The tracks 42A, B, C may also include a vertical segment 42C extending in the vertical direction to provide movement of the battery pack 32 in the vertical direction. As can be appreciated by FIG. 3, positioning the battery pack 32 in a chamber 50 beneath the floor 24 may permit a substantial range of movement of the battery pack 32, particularly in the longitudinal direction. The tracks 42A, B, C and battery pack 32 may be positioned on a sub-floor 25 in the chamber 50. As shown, the battery 32 shown in solid lines illustrates a first position of the battery pack 32 adjacent to the stern region 12, and the battery pack 32 shown in broken lines illustrates as second position of the battery pack 32 adjacent to bow region 14. This permits operators to drastically impact a front-to-back weight distribution of the boat to provide desired operating characteristics.

As further shown in FIG. 3, the electric outdrive 26 may also be located in the chamber 50 beneath the floor 24. As with the previously described embodiments, this electric outdrive 26 may include an electric motor 28 connected to a propeller 30 for generating thrust in water to drive the boat 10. Furthermore, a rudder 52 may be located behind the propeller 30 for steering the boat 10.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

What is claimed is:

1. An electric motor powered boat, comprising:
a hull extending between a bow region and a stern region;
an electric motor for driving the boat;
at least one battery pack electrically connected to the electric motor for powering the electric motor; and
the battery pack moveable relative to the hull for relocating a center of mass of the battery pack.

2. The electric motor powered boat as set forth in claim 1, wherein the battery pack is configured to move in a width direction between sidewalls of the boat.

3. The electric motor powered boat as set forth in claim 2, wherein the battery pack is configured to move in a length direction extending between the bow region and the stern region of the boat perpendicular to the width direction.

4. The electric motor powered boat as set forth in claim 1, further including a track overlying the hull, and wherein the battery pack is coupled with the track to accommodate movement of the battery pack.

5. The electric motor-powered boat as set forth in claim 4, further including a pack motor configured to drive movement of the battery pack along the track.

6. The electric motor-powered boat as set forth in claim 5, wherein the pack motor is electrically connected to the battery pack to power the pack motor.

7. The electric motor powered boat as set forth in claim 4, wherein the track includes at least one width segment extending in the width direction to provide movement of the battery pack in the width direction.

8. The electric motor powered boat as set forth in claim 7, wherein the track further includes at least one length segment extending in a length direction extending between the bow and the stern to provide movement of the battery pack in the length direction.

9. The electric motor powered boat as set forth in claim 1, further including a seat adjacent to the transom and defining a compartment, and wherein the battery pack is located in the compartment of the seat.

10. The electric motor powered boat as set forth in claim 9, wherein the battery pack is moveable within the compartment of the seat.

11. The electric motor powered boat as set forth in claim 10, wherein a track is located in the compartment of the seat, and the battery back is coupled to the track and moveable along the track within the compartment of the seat.

12. The electric motor powered boat as set forth in claim 9 wherein the seat is moveable with the battery pack while the battery pack is located in the compartment of the seat.

13. The electric motor powered boat as set forth in claim 12, wherein the seat is configured to be positioned in a plurality of locked positions, and wherein the electric motor is only configured to be driven in response to a detection that the seat is in the locked position.

14. The electric motor powered boat as set forth in claim 5, wherein the pack motor is electrically connected to a controller for controlling movement of the battery pack for allowing a user to control movement of the battery pack.

15. The electric motor powered boat as set forth in claim 14, wherein a mobile device is connected to the controller for controlling the pack motor for further allowing a user to selectively control movement of the battery pack.
